(19) United States
(12) Patent Application Publication
(10) Pub. No.: US 2012/0186656 A1
(43) Pub. Date: Jul. 26, 2012

(54) HYDRATION SYSTEM

(75) Inventor: Peter Fitzgerald, Boston, MA (US)

(73) Assignee: Hydrathon, LLC, Boston, MA (US)

(21) Appl. No.: 13/388,532

(22) PCT Filed: Aug. 3, 2010
(86) PCT No.: PCT/US2010/044207

§ 371 Date: Apr. 11, 2012

Related U.S. Application Data
(60) Provisional application No. 61/230,928, filed on Aug. 3, 2009.

(51) Int. Cl. B62J 11/00; E03B 1/00

(52) U.S. Cl. 137/1; 224/414

(57) ABSTRACT

A bicycle-mountable hydration system includes a first and a second bladder, each-configured to hold liquid, and a holder configured to be supported by a top bar of a bicycle. The holder has first and second outward-facing sides and first and second inward-facing sides. The holder includes a left portion that is configured to receive the first bladder at the first-inward-facing side and a right portion that is configured to receive the second bladder at the second inward-facing side and a middle portion connecting the left portion and the right portion. When the holder is supported by a top bar of a bicycle, the first-inward-facing side of the left portion faces the first-inward-facing side of the right portion. The middle portion may hang over the top bar of the bicycle to support the holder with the first bladder on an opposite side of the top bar from the second bladder. The system may be convertible to function as a hydration backpack when removed from the bicycle.

### FIELD OF THE INVENTION

This invention relates generally to hydration systems, and more specifically to bicycle-mountable hydration systems.

### DISCUSSION OF THE RELATED ART

A hydration system is used to supply liquid to a person during a physical activity. Preferably, a hydration system supplies liquid to the person in a manner that reduces interference with the physical activity. For example, a bicyclist who uses a typical water bottle mounted in a bottle cage on a bicycle is required to remove at least one hand from the handlebars of the bicycle to reach for the water bottle, which can be inconvenient and may slow the rider.

A common hydration system for runners and bicyclists includes a bladder stored in a backpack that is worn on the back of the runner or bicyclist. A tube extends from the inflatable bladder to the mouth of the user to supply liquid to the user without occupying the user's hand during drinking while running or bicycling. Such a system is worn by the rider of the bicycle and is not mounted or attached to the bicycle. This arrangement allows a person to transition quickly and easily from riding a bicycle to running or walking without removal of the hydration backpack. Quick and easy transitions between activities may be especially important to people who participate in sports that include both bicycling and running, such as triathlons.

### SUMMARY

Embodiments of the invention provided herein include bicycle-mountable hydration systems with one or more bladders, convertible bicycle-mountable personal hydration systems, and methods of using a bicycle-mountable hydration systems. According to one embodiment, a bicycle-mountable hydration system includes a first bladder, a second bladder and a holder. Each of the first and second bladders is configured to contain liquid and each has a port. The holder includes first and second outward-facing sides and first and second inward-facing sides. The holder includes a left portion configured to receive the first bladder, a right portion configured to receive the second bladder and a middle portion connecting the left portion and the right portion. The holder is configured to be supported by a top bar of a bicycle such that a first inward-facing side of the left portion faces a second inward-facing side of the right portion.

In some embodiments, the middle portion may be configured to hang over the top bar of a bicycle along a substantial length of the top bar and distribute a weight of the holder, the first and second bladders, and the liquid contained in the first and second bladders. The middle portion of the holder may have sufficient strength to support at least the weight of the holder, the first bladder full of liquid and the second bladder full to of liquid without substantial stretching of the middle portion. The holder may include a deformable material. An inward-facing side of the middle portion of the holder may include a material having sufficient grip to prevent sliding of the holder relative to a top bar of a bicycle.

In some embodiments, the left portion of the holder is configured to receive the first bladder at the first inward-facing side and the right portion of the holder is configured to receive the second bladder at the second inward-facing side. The first bladder may be accessible from the first inward-facing side and the second bladder may be accessible from the second inward-facing side. The system may also include a first tube connected to at least the port of the first bladder for delivery of a liquid from the first bladder and a second tube connected to at least the port of the second bladder for delivery of a liquid from the second bladder. The first tube may include an outlet configured to deliver liquid to a user's mouth. The system may include a third tube connected to the first tube and connected to the second tube, where the third tube is configured to deliver liquid from the first tube to a user and to deliver liquid from the second tube to a user. The system may also include a switchable coupler configured to adjust a fluid connection between the first tube and the third tube, and configured to adjust a fluid connection between the second tube and the third tube.

According to another embodiment, a convertible bicycle-mountable personal hydration system includes a first bladder and a second bladder, each of the first bladder and the second bladder being configured to contain liquid and each having a port. The system also includes a holder having left portion configured to receive the first bladder, a right portion configured to receive the second bladder, and a middle portion connecting the left portion and the right portion. The middle portion is configured to support the holder and the first and second bladders from a top bar of a bicycle such that a first inward-facing side of the left portion faces the second inward-facing side of the right portion when the system is mounted on the bicycle. The system also includes a first strap connected with the holder with the first strap and holder being configured to receive a user's arm and support the holder and the bladders such that the holder contacts the user's back.

In some embodiments, the system also may also include a second strap connected with the holder where the second strap and holder are configured to receive a user's other to arm and configured to support the holder and the bladders such that the holder contacts the user's back. The first strap and the holder may be configured to support the holder and the bladders such that the first inward-facing side of the right portion of the holder and/or the second inward-facing side of the left portion of the holder contact the user's back. The first strap may attach to the inward-facing side of the holder. The holder may also include a down tube attachment element configured to attach the holder to a down tube of a bicycle, and a seat tube attachment element configured to attach the holder to a seat tube of a bicycle. The system may also include a waist belt having a first part attached to the left portion of the holder and a second part attached to the right portion of the holder.

In some embodiments, the holder may also include a first tube guide configured to position a tube extending from the port of the first bladder and/or the port of the second bladder. The first tube guide may be configured to position the tube to extend toward a front end of a bicycle when the system is mounted on the bicycle. The holder may also include a second tube guide configured to position a tube extending from the port of the first bladder or the port of the second bladder. The holder may also include at least one pocket that is dimensioned to hold a bicycle pump and that is accessible from the first and/or the second outward-facing side of the holder.

According to a further embodiment, a method of drinking liquid from first and second bladders includes adding liquid to first and second bladders and mounting the first and second bladders to a bicycle with a holder. The method also includes drinking liquid from the first bladder via a tube while the bladders are mounted to the bicycle and drinking liquid from the second bladder via a tube while the bladders are mounted to the bicycle. The method further includes removing the holder and the first and second bladders from the bicycle and wearing the holder as a backpack, drinking liquid from the first bladder via a tube while the holder is worn as a backpack, and drinking liquid from the second bladder via a tube while the while the holder is worn as a backpack.

In some embodiments, mounting the first and second bladders to a bicycle with a holder may include placing the holder over a top bar of the bicycle such that the first bladder hangs from one side of the top bar and the second bladder hangs from a second side of the top bar, opposite the first side. The method may also include placing the first bladder into a left portion of the holder and placing the second bladder into a right to portion of the holder. The first bladder may be placed into a first inward-facing side of the left portion of the holder and the second bladder may be placed into a second inward-facing side of the right portion of the holder.

Various embodiments of the present invention provide certain advantages. Not all embodiments of the invention share the same advantages and those that do may not share them under all circumstances. Further features of embodiments of the present invention, as well as the structure of various embodiments of the present invention are described in detail below with reference to the accompanying drawings.

### DESCRIPTION OF FIGURES

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a side view of a hydration system mounted on a bicycle, in accordance with one illustrative embodiment;

FIG. 1B is a plan view of the hydration system depicted in FIG. 1A detached from the bicycle and opened to show outward-facing sides;

FIG. 1C is a plan view the hydration system depicted in FIG. 1A opened to show inward-facing sides;

FIG. 1D is a front view of the hydration system depicted in FIG. 1A opened to shown inward-facing sides with backpack straps attached;

FIG. 1E is a back view of the hydration system depicted in FIG. 1A being worn as a backpack;

FIG. 1F is a back view of the hydration system depicted in FIG. 1A being worn in another backpack configuration;

FIG. 2A is a plan view of a first bladder with a first port, and a first tube with a first outlet, in accordance with some embodiments;

FIG. 2B is a plan view of a fluid coupler for connecting a first tube from a first bladder and a second tube from a second bladder with a third tube, in accordance some with embodiments;

FIG. 2C is a plan view of a switchable fluid coupler for adjusting a fluid connection from between the first tube and the third tube to between the second tube and the third tube, in accordance with some embodiments;

FIG. 2D is a plan view of another bladder, in accordance with some embodiments;

FIGS. 3A-3C depict systems with various holder structures for attaching the systems to a bicycle, in accordance with various embodiments;

FIG. 4A is a side view of a hydration system mounted on a bicycle, in accordance with another illustrative embodiment;

FIG. 4B is a plan view of the hydration system depicted in FIG. 4A detached from the bicycle and opened to show outward-facing sides;

FIG. 4C is a plan view the hydration system depicted in FIG. 4A opened to show inward-facing sides;

FIG. 4D is a front view of the hydration system depicted in FIG. 4A with backpack straps attached;

FIG. 4E is a back view of the hydration system depicted in FIG. 4A being worn as a backpack;

FIG. 5A is a front view of a hydration system, in accordance with another illustrative embodiment;

FIG. 5B is a back view of the hydration system depicted in FIG. 5A; and

FIG. 6 is a flow chart of a method of drinking liquid, in accordance with one embodiment.

### DETAILED DESCRIPTION

Applicants have appreciated that although backpack hydration systems may permit a cyclist to transition between activities quickly, covering the user's back with a backpack during cycling may significantly reduce the user's ability to cool off. Further, carrying a substantial volume of liquid in a backpack while cycling may put strain on a cyclist's back when compared with mounting a liquid carrying system directly on a bicycle. A bicycle-mounted liquid carrying system should be securely mountable to a bicycle to prevent the system, or portions of the system, from detaching or shifting in a manner that would interfere with either the cyclist or the bicycle.

Embodiments of the invention include a bicycle-mountable hydration system for providing liquid to a user during a physical activity. The hydration system includes two or more bladders for holding liquid, and a holder, which is configured to receive the two or more bladders and is configured to be supported by a top bar of a bicycle. In an exemplary embodiment, a first inward-facing side of a left portion of the holder is configured to receive a first bladder, and a second inward-facing side of a right portion of the holder is configured to receive a second bladder. Thus, access to the bladders is provided on the inward-facing sides of the holder. When supported by a top bar of a bicycle, the first inward-facing side of the left holder portion faces the second inward-facing side of the right holder portion. Because the first and second bladders are received on the inward-facing sides of the holder, which face each other when the holder is mounted on a bicycle, the first and second bladders may have increased protection from damage during cycling by the material of outward-facing sides of the holder. The material of outward-facing sides of the holder also may prevent sunlight from directly striking the bladders, thereby reducing solar heating of the liquid stored in the bladders.

The system may be configured to securely attach to a bicycle, and also may be configured to attach and detach from a bicycle quickly and easily. In some embodiments, the system may be configured to easily convert to a backpack hydration system for quick transitions from cycling to running or vice versa.

The two bladders may enable an exemplary bicycle-mounted hydration system to carry large volumes of liquid, as compared to a conventional backpack hydration system. Additionally, having more than one bladder may provide a user with access to different liquids at the same time. The system may have one tube to drink from both bladders and/or may have a separate tube for drinking from each bladder. In some embodiments, the system may have a switchable coupler permitting a rider to select which bladder is fluidly connected with a drinking tube, or permitting a rider to fluidly connect both bladders with the drinking tube simultaneously.

The holder suspends the hydration system from a top bar of a bicycle in some embodiments. Friction between the top bar of the bicycle and the holder may exert substantial force to prevent the system from sliding with respect to the top bar. The holder may hang over the top bar to suspend the first liquid bladder on one side of the top bar and to suspend the second liquid bladder on an opposite side of the top bar. Hanging to the holder over a top bar may reduce the likelihood of the system unexpectedly detaching from the bicycle when compared with a system that attaches to, but does not hang over, the top bar.

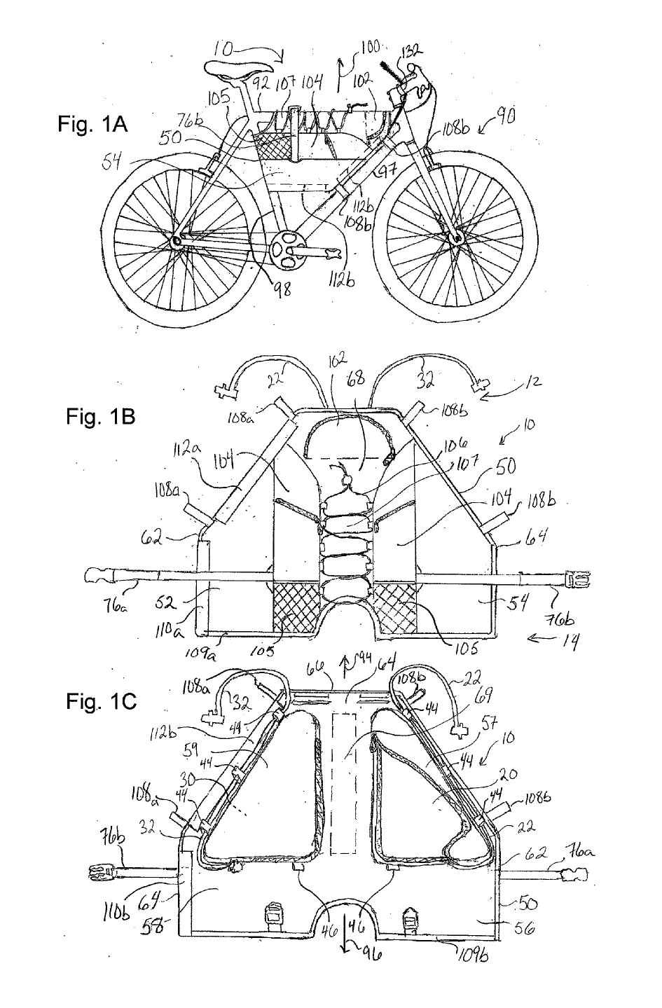

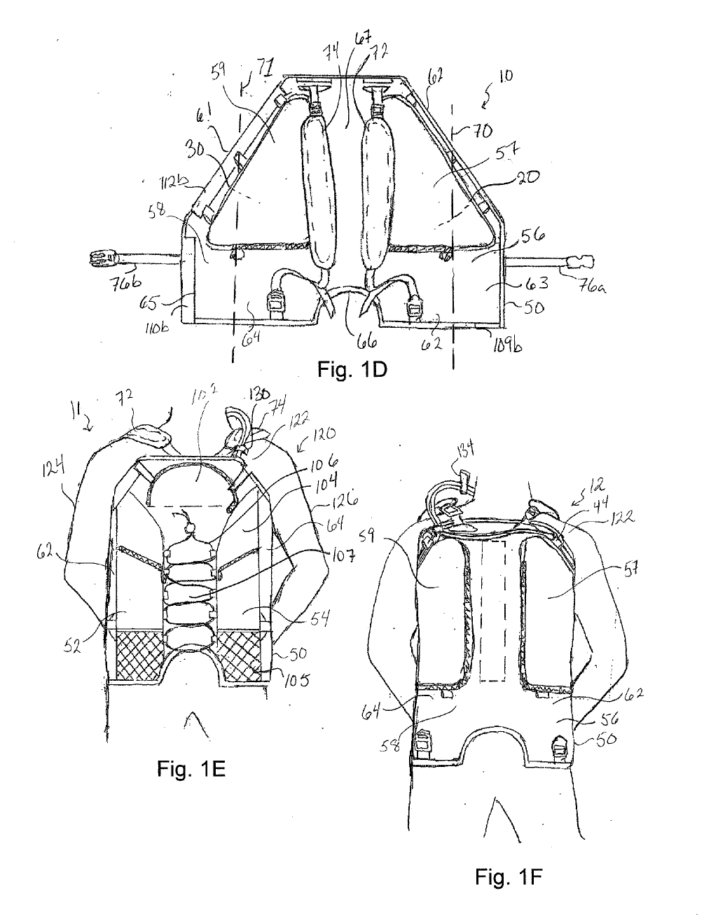

One particular embodiment of a bicycle mountable hydration system is shown in FIGS. 1A-1E. In this embodiment, a bicycle-mountable hydration system 10 includes a holder 50, a first bladder 20 and second bladder 30, with each bladder being configured to contain liquid and each bladder including a port configured to permit liquid flow. A tube may be connected to each port to convey fluid from the bladder to the cyclist's mouth. In the embodiment of FIGS. 1A-1E, a first tube 22 is connected with first bladder 20 for delivery of liquid from first bladder 20, and a second tube 32 is connected with second bladder 30 for delivery of a liquid from second bladder 30.

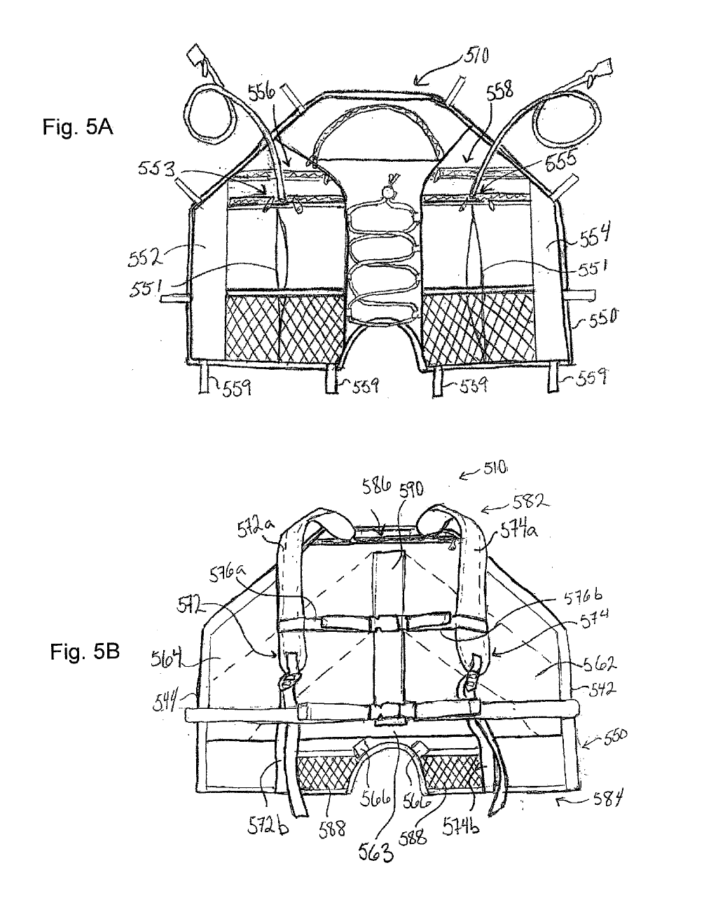

Holder 50 is configured to receive the bladders and secure them to a bicycle 90. Holder 50 has a first outward-facing side 52 and a second outward-facing side 54, as shown in FIG. 1B, as well as a first inward-facing-side 56 and a second inward-facing side 58 as shown in FIG. 1C. A left portion 62 of holder 50 is configured to receive first bladder 20 on a first inward-facing side 56, and a right portion 64 of holder 50 is configured to receive second bladder 30 on a second inward-facing side 58, as shown in FIG. 1C. Holder 50 is configured to be supported by a top bar 92 of bicycle 90, as shown in FIG. 1A, such that first inward-facing side 56 of the left portion 62 faces second inward-facing side 58 of the right portion 64. Although holder 50 is configured to receive bladders on inward-facing sides of left and right holder portions, in other embodiments, a holder may be configured to receive bladders on outward-facing sides of left and right portions, as explained below with respect to FIGS. 5A and 5B.

In some embodiments, bicycle-mountable hydration system 10 is convertible to a backpack configuration 11 having at least one strap 72, as shown in FIGS. 1D and 1E. In FIG. 1D, first tube 22 and second tube 32 are omitted for clarity. In a backpack configuration, system 10 is configured to support holder 50, first bladder 20 and second bladder 30 such that at least part of holder 50 contacts a back 122 of a user 120. As shown, a first strap 72 and a second strap 74 each attach to holder 50. In some embodiments, an outer part 63 of left portion 62 may fold inward along line 70 (shown in FIG. 1D) and an outer part 65 of right portion 64 may fold inward along line 71 resulting in a backpack configuration shown in FIG. 1E. First strap 72 and holder 50 may be configured to receive a user's arm 124 and support holder 50 and bladders 20, 30 such that first inward-facing sides 56 of left portion and second inward-facing side 58 of right portion of holder 50 at least partially contact user's back 122, as shown in FIG. 1E. Second strap 74 may be configured to receive the user's other arm 126 and support holder 50 and bladders 20, 30 such that inward-facing sides 56, 58 at least partially contact user's back 122. Although first strap 72 and second strap 74 are shown attached to inward-facing sides of holder 50, in other embodiments, one or more straps may attach to one or more outward-facing sides of a holder, and/or may be attached to an outer perimeter of the holder, as the invention is not limited in this regard. As depicted, buckles are used to removably attach each end of first strap 72 and second strap 74 to holder 50. Of course, other elements and mechanisms may be used to attach one or more straps to a holder. In some embodiments, an end of each strap may be permanently affixed to the holder.

In some embodiments, outer left part 63 may fold toward a first outward-facing side 52 of left portion 62 and outer right part 65 may fold toward a second outward-facing side 54 of right portion resulting in a backpack configuration 12 shown in FIG. 1F. In this configuration, at least part of first outward-facing side 52 and second outward-facing side 54 face toward the user's back 122. System 10 also may include a waist belt having a first part 76a, which is attached to left holder portion 62, and a second part 76b, which is attached to right holder portion 64, with the waist belt being configured to encircle a user's waist. As depicted, waist belt 76a, 76b is permanently attached to holder 50; however, in other embodiments, one or both parts of a waist belt may be detachable from a holder.

Returning to FIGS. 1A-1C, holder 50 may be configured to be supported by top bar 92 of bicycle 90. In some embodiments, middle portion 66 of holder 50 is configured to hang over top bar 92 along a substantial length of top bar 92, and distributes the weight of holder 50, first bladder 20, second bladder 30, and the liquid contained the bladders. An inward-facing side 67 of middle portion 66 may include a material 69 having sufficient grip to prevent sliding of holder 50 relative to top bar 92. Examples of a material having sufficient grip include, but are not limited to: neoprene, rubber, latex or any material that can be modified with gripping elements or a gripping texture. Middle portion 66 may have sufficient strength to support at least the weight of to holder 50, first bladder 20 full of liquid and second bladder 30 full of liquid without substantial stretching of middle portion 66.

Holder 50 may be formed of one or more deformable materials and also may include one or more semi-rigid or rigid materials. Examples of deformable formable materials that may be used for the holder include, but are not limited to, neoprene, nylon, ballistic (heavy duty) nylon, canvas, and mesh.

Although the weight of system 10 may be substantially supported by top bar 92, system 10 may include one or more attachment elements configured to attach, couple and/or secure system 10 to parts of bicycle 90. For example, system 10 may include down tube attachment elements 108a, 108b configured to attach holder 50 to a down tube 97 of bicycle 90, as shown in FIGS. 1A and 1B. Each down tube attachment element 108a, 108b may be connected to holder 50 near a leading edge of left holder portion 62 or a leading edge of right holder portion 64. When mounting system 10 on bicycle 90, down tube attachment element 108a on left holder portion 62 may be extended around down tube 97 and fastened to corresponding down tube attachment element 108b on right holder portion 64, thereby coupling the leading edges of left holder portion 62 and right holder portion 64 to down tube 97.

Holder 50 also may include leading edge attachment elements 112a, 112b that attach leading edges of holder 50 to each other when holder 50 is mounted on a bicycle. Holder 50 may include bottom edge attachment elements 110a, 110b which attach bottom edges of holder 50 to each other when holder 50 is mounted on a bicycle. Leading edge attachment elements 112a, 112b and bottom edge attachment elements 110a, 110b may increase protection of first bladder 20 and second bladder 30 during cycling and may reduce aerodynamic drag of the holder during cycling. System 10 may also include trailing edge attachment elements 109a, 109b that enable trailing edges of holder 50 to attach to each other after being wrapped around a seat tube 98 of bicycle 90. System 10 may be removed from bicycle 90 by unfastening down tube attachment elements 108a, 108b, bottom edge attachment elements 110a, 110b, leading edge attachment elements 112a, 112b, and trailing edge attachment elements 109a, 109b and lifting holder 50 as indicated by arrow 100 in FIG. 1A.

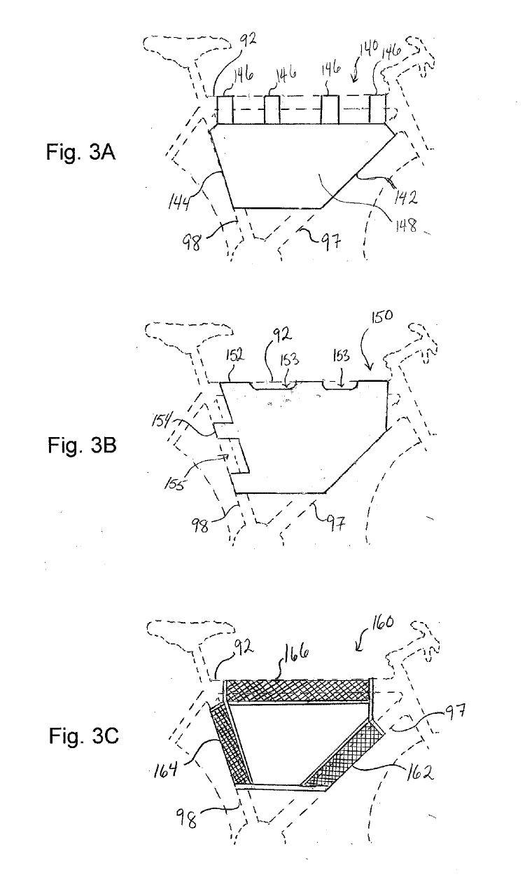

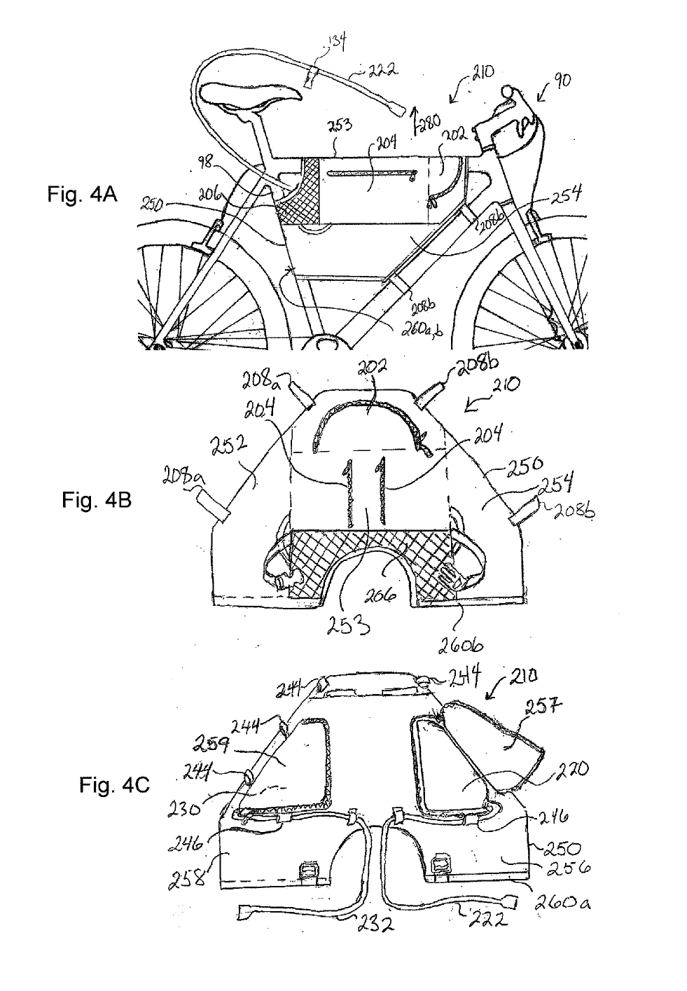

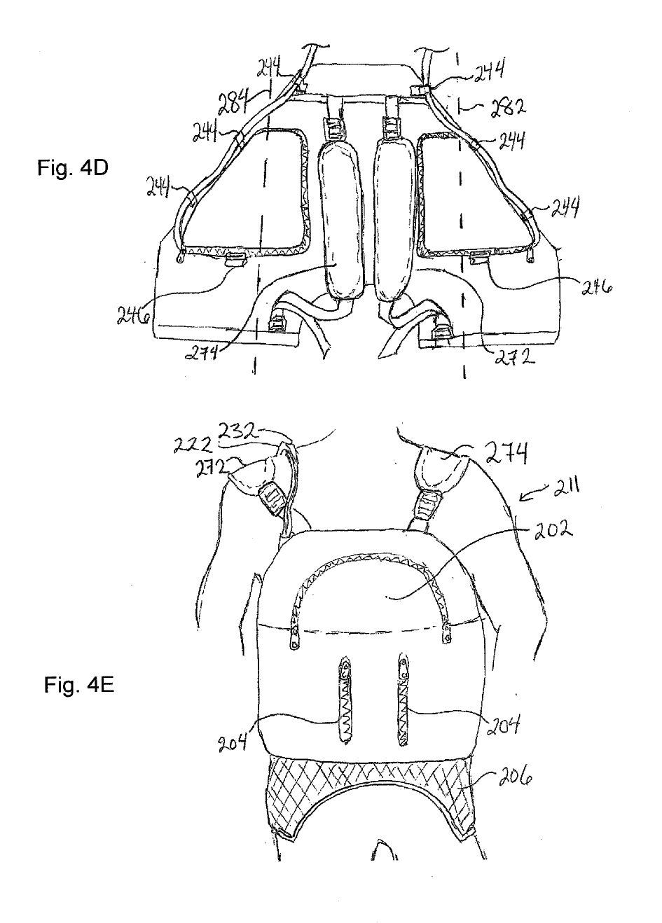

Although down tube attachment elements 108a, 108b, leading edge attachment elements 112a, 112b, bottom edge attachment elements 110a, 110, and trailing edge attachment elements 109a, 109b employ hook and loop fasteners (e.g. VELCRO®), attachment elements may incorporate any known attachment material or mechanism. For example, down tube attachment elements 108a, 108b may include elasticized straps with fastening elements, such as snaps. In some embodiments, attachment elements may be fastening strips attached to a side of holder 50, (e.g., leading edge attachment elements 112a, 112b, bottom edge attachment elements 110a, 110b, trailing edge attachment elements 109a, 109b, etc.). In some embodiments, attachment elements may extend from holder 50 (e.g., down tube attachment elements 108a, 108b). A system may include more or fewer attachment elements, which may be located on various portions of a holder to attach to various portions of a bicycle, as the invention is not limited in this respect unless explicitly recited in the claims. Various embodiments of holders and attachment elements are presented and described further below with respect to FIGS. 3A-3C and FIGS. 4A-4E.

Bladders may be received and held in interior pockets attached to inward-facing surfaces of a holder. For example, FIG. 1C shows an open first interior pocket 57 that receives and holds first bladder 20. A second interior pocket 59 holds second bladder 30. In some embodiments, zippers may be used to open and close first interior pocket 57 and second interior pocket 59. An opening of first interior pocket 57 may also have a zipperless portion through which a tube 22 may extend, as depicted in FIG. 1C. However, in some embodiments, other types of fasteners (e.g., snaps, buttons, hooks, straps, hook and loop material, etc.) may be used to control access to a bladder. In some embodiments, an interior pocket may not use fasteners, but instead may be shaped to secure a bladder in the pocket during use. In other embodiments, a bladder and holder may be configured to attach the bladder directly to the holder, instead of, or in addition to, the bladder being received in an interior pocket.

Holder 50 may include one or more tube guides. For example, FIG. 1C shows first tube guides 44, which direct first tube 22 and second tube 32 toward a front of bicycle 90 as indicated by arrow 94. Holder 50 also includes second tube guides 46, which are configured to direct first tube 22 and second tube 32 toward a rear of a bicycle as indicated by arrow 96. For example, FIGS. 4A and 4D, described below, show an embodiment with tubes directed toward a rear of a bicycle. A rider may wish to couple first tube 22 and second tube 32. For example, first tube 22 and second tube 32 may be coupled with a clip 130, as shown in FIG. 1E, or first tube 22 and second tube 32 may be directed through a same tube guide 44, as shown in FIG. 1F. Systems with other types or arrangements of tube guides and systems with no tube guides also fall within the scope of the invention.

System 10 may include additional attachment elements that secure one or more tubes 22, 23 to portions of bicycle 90 and/or rider 11. For example, system 10 may include clip 132 configured to secure tubes 22, 32 to a handlebar of bicycle 90, as shown in FIG. 1A. As another example, system 10 may include a clasp 134, shown in FIG. 1F, configured to secure tubes to rider 11, holder 50 and/or another object.

System 10 may include one or more outer pockets accessible from an outward-facing side of the holder (e.g., first outward-facing side 52, second outward-facing side 54, an outward-facing side of middle portion 68, etc.). An outer pocket may be configured to hold one or more personal items (e.g., a wallet or a mobile phone), may be configured to hold supplies or equipment for biking or running (e.g., food, a bicycle pump, or a bicycle tire inner tube), and/or may be configured to hold items for converting the system for use as a hydration backpack (e.g., shoulder straps, a coupling for attaching shoulder straps or a waist strap). For example, FIGS. 1A and 1B show a first outer pocket 102 that may be sized to hold personal items and/or to hold bicycle equipment. First outer pocket 102 may be located toward a front end 12 of the system to provide easy access while cycling. Second outer pockets 104 may be sized and/or configured to hold a bicycle pump, an edible energy bar and other similarly sized items. System 10 may include additional pockets, such as an outer mesh pocket 105, to hold other items. As illustrated, outer pockets may be located in any one or more of left holder portion 62, right holder portion 64 and middle holder portion 66. Further, an outer pocket may span multiple portions of the holder (e.g., pocket 102 of FIGS. 1A and 1B, pockets 202 and 206 in FIGS. 4A-4B, etc.). Holder 50 may include additional elements for securing items to holder 50. For example, an elastic strap 106 may be attached to holder 50 defining an elastic strap pocket 107.

Although system 10 is configured for enabling access to first bladder 20 and second bladder 30 from first inward-facing side 56 of left portion and second inward-facing side 58 of right portion of holder 50, in some embodiments, first bladder 20 and second bladder 30 may be accessible from inward-facing sides and/or outward-facing sides of a holder. In some embodiments first bladder 20 and second bladder 30 are only accessible from outward-facing sides of a holder as described below with respect to FIGS. 5A and 5B. Although system 10 includes a first bladder which is physically separate from a second bladder, in some embodiments, a first bladder may be physically joined to a second bladder and/or may be formed integrally with a second bladder. For example, a first bladder and a second bladder may be connected by material that spans a middle portion of a holder and may be received in a large interior pocket that extends from a left portion of the holder to a right portion of the holder.

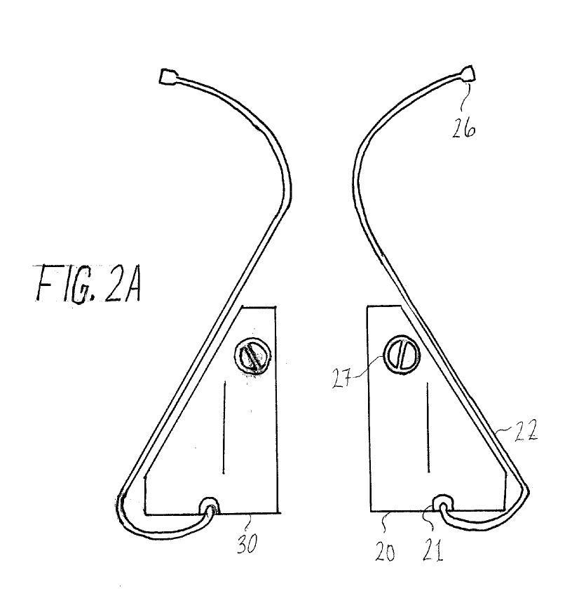

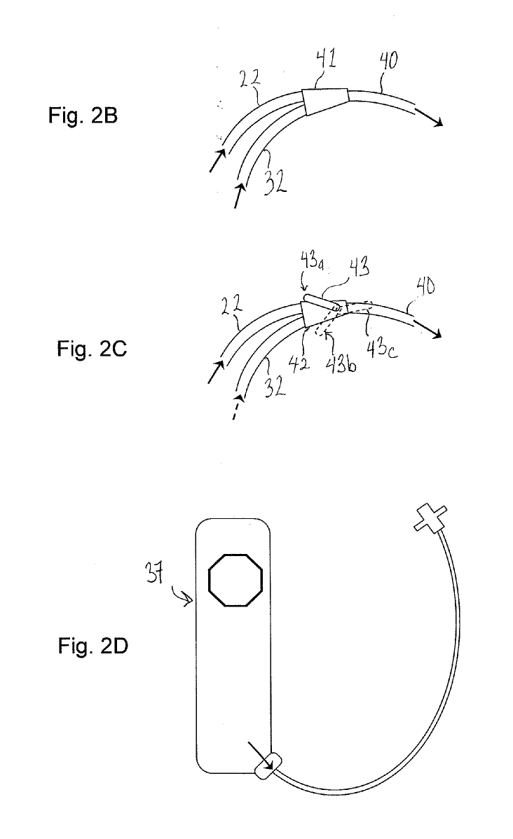

FIG. 2A shows first bladder 20 having a first port 21 and first tube 22 that is connected to first port 21 for delivery of a liquid from the first bladder 20. In some embodiments first tube 22 may include a first outlet 26 configured to deliver liquid to a user's mouth. First outlet 26 may include a bit valve or another delivery element. In some embodiments, first outlet 26 may be detachable from first tube 22, which may allow a user to easily clean first outlet 26 or replace first outlet 26. First bladder 20 may include a separate inlet port 27 for filling bladder 20 as shown. In other embodiments, a single port may be used for supplying liquid to a tube and for filling a bladder with liquid. First bladder 20 may include a partial seam 28, along which bladder 20 may be folded. The description of features and elements of first bladder 20, first port 24, first tube 22, first outlet 26 and inlet port 27 also may apply to corresponding elements for second bladder 30.

In some embodiments, system 10 includes a third tube 40 that fluidly couples with first tube 22 and/or second tube 32, as shown in FIGS. 2B and 2C. Third tube 40 is configured to deliver liquid from first tube 22 to a user and from second tube 32 to a user. In some embodiments, a coupler 41 may be used to simultaneously fluidly couple both first tube 22 and second tube 32 with third tube 40 as shown in FIG. 2B. A switchable coupler 42 may be used to adjust a fluid connection from between first tube 22 and third tube 40 to between second tube 32 and third tube 40, as shown in FIG. 2C. For example, with a switch 43 in a first position 43a, first tube 22 is fluidly coupled with third tube 40. With switch 43 in a second position 43b, second tube 32 is fluidly coupled with third tube 40. With switch 43 in a third position 43c, neither first tube 22 nor second tube 32 is coupled with third tube 40. In some embodiments, bladder(s), tube(s), port(s), outlet(s) and/or coupler(s) may include one or more valves to control liquid to and/or to prevent backflow.

Although first bladder 20 and second bladder 30 have substantially triangular shapes that mirror each other, as illustrated by FIG. 2A. In some embodiments, a first bladder and second bladder may have various shapes which mirror each other, may have shapes that do not mirror each other and/or may have shapes that are substantially different from each other. For example, FIG. 2D shows a bladder 37 having a substantially rectangular shape.

FIGS. 3A-3C depict various embodiments of holders. A holder 140 may include leading edges 142 that wrap around down tube 97 of bicycle 90 and trailing edges 144 that wrap around seat tube 98 of bicycle 90, as shown in FIG. 3A. Holder 140 may include straps 146 that suspend a left portion (not shown) of the holder and a right portion 148 of the holder from top bar 92. In another embodiment, a holder 150 may include a middle portion 152 with openings 153 along a top bar 92, as shown in FIG. 3B. Holder 150 may include trailing edges 154 that wrap around seat tube 98 with openings 155. In yet another embodiment, a holder 160 may include a middle portion of mesh 166, leading edges 162 of mesh that wrap around down tube 97 and/or trailing edges 164 of mesh that wrap around seat tube 98, as shown in FIG. 3C. Other configurations of holders also fall within the scope of the invention.

FIGS. 4A-4E depict a bicycle-mountable hydration system 210 in accordance with another embodiment. As shown in FIGS. 4A and 4B, system 210 includes a holder 250, which may have one or more pockets on outward-facing sides 252, 254 of the holder. Holder 250 may include pockets 204, which may be configured to hold a bicycle pump or other gear, on outward-facing sides 252, 254 of holder 250. Holder may include one or more pockets that extend across one or more of first outward-facing side 252, a middle outward-facing side 253 and second outward-facing side 254, (e.g., a first pocket 202, a mesh pocket 206, and/or other pockets).

A trailing edge of holder 50 may be configured to wrap around a seat tube 98 of a bicycle 90. For example, first inward-facing side 256 of holder 50 may include a first seat tube fastening element 260a that is configured to attach to a corresponding second seat tube fastening element 260b on second outward-facing side 254 of holder 50.

As shown in FIGS. 4C and 4D, holder 250 may have pockets 257, 259 on inward-facing sides 256, 258 to receive bladders 220, 230. Holder 250 may include first tube to guides 244 to position a first tube 222 and/or a second tube 232 to extend toward a front of a bicycle 90, as shown in FIG. 4D. Holder 250 may also or alternatively include second tube guides 246 to direct a first tube 222 and/or second tube 223 toward a rear of a bicycle 90, as shown in FIGS. 4A and 4C. In some embodiments, tube guides may position a tube to extend toward a front of a bicycle and may be adjustable to position a tube to extend toward a rear of a bicycle.

Although exemplary systems 10 and 210 include a holder, a first bladder and a second bladder, embodiments of the invention need not include a first bladder and a second bladder. For example, an exemplary embodiment may include a holder configured to receive a first bladder and a second bladder, but not include a first bladder and/or a second bladder, as the invention is not limited in this respect except to the extent recited in the claims.

System 210 may be configured to quickly and easily convert from a bicycle-mounted configuration, as shown in FIG. 4A, to a backpack configuration 211, as shown in FIG. 4E. System 210 may be removed from a bicycle by detaching down tube attachment elements 208a, 208b and seat tube attachment elements 260a, 260b and lifting holder 50 as indicated by arrow 280. System 210 may include a first strap 272 and/or a second strap for converting the system to a backpack configuration 211. After removal from the bicycle, first strap 272 and/or second strap 274 may be attached to holder 50, and holder may be folded along lines 282 and 284 converting the system 210 to the backpack configuration 211 shown in FIG. 4E.

FIGS. 5A and 5B illustrate an exemplary embodiment in which bladders are accessible from outward-facing sides of a holder. System 510 includes a holder 550 that has a left portion 542 with a first outward-facing side 552 and a right portion 544 with a second outward-facing side 554. First outward-facing side 552 includes a first outer pocket 553 configured to receive a first bladder 520 and second outward-facing side 554 includes a second outer pocket 555 configured to receive second bladder 530. First outer pocket 553 and second outer pocket 555 each may have one or more pleats 551 or other elements that allow greater pocket expansion, as shown by FIG. 5A. First outward-facing side 552 and second outward-facing side 554 each may have one or more additional pockets. For example, first outward-facing side 552 may have a third outer pocket 556 that underlies first outer pocket 553, and second outward-facing side 554 may to have a fourth outer pocket 558 that underlies second outer pocket 555. Holder 550 may also include seat tube attachment elements 559. Third outer pocket 556 and fourth outer pocket 558 may be configured to hold personal items (e.g., telephone, wallet) and/or bicycle tools and parts (e.g., bicycle pump, spare inner tube).

Holder 550 also has a first inward-facing side 562 of left portion 542 and a second inward-facing side 564 of right portion 544. Unlike holder 50 of system 10 shown by FIGS. 1A-1F, in the embodiment shown in FIGS. 5A and 5B, neither first inward-facing side 562 nor second inward-facing side 564 includes a pocket configured to receive first bladder 20 or second bladder 30.

FIG. 5B illustrates additional features which may be incorporated into various embodiments. For example, a middle inward-facing portion 563 includes tube guides 566 for guiding one or more tubes toward a back of a bicycle. A first strap 572 may include a top strap portion 572a attached at or near a leading edge 582 of holder 550 and a bottom strap portion 572b attached at or near a trailing edge 584 of the holder. Similarly, a second strap 574 may include a top strap portion 574a and a bottom strap portion 574b. A chest strap having a first part 576a connected with the first strap 572 and a second part 576b connected with the second strap 574 may be configured to connect first strap 572 and second strap 574 across a wearer's chest. When the system 550 is configured to be mounted on a bicycle, top strap portions 572a, 574a may be disconnected from holder 550 or stored in a leading edge pocket 586, and bottom strap portions 572b, 574b may be stored in mesh pockets 588. Middle inward-facing portion 563 may include an element 590 configured to contact the top bar of a bicycle and provide additional friction between holder 550 and the top bar and/or to provide additional strength to holder 550.

Not all bicycles have a horizontal top bar. For example, some bicycles have a top bar that is slightly slanted and some have a top bar that is substantially slanted and/or curved. For example, various attachment elements of a holder may be adjustable to adapt to a non-horizontal top bar and or to a curved top bar. As another example, for a bicycle without a suitable top bar, a system may include a flexible tension bar configured to secure to the bicycle and support a holder.

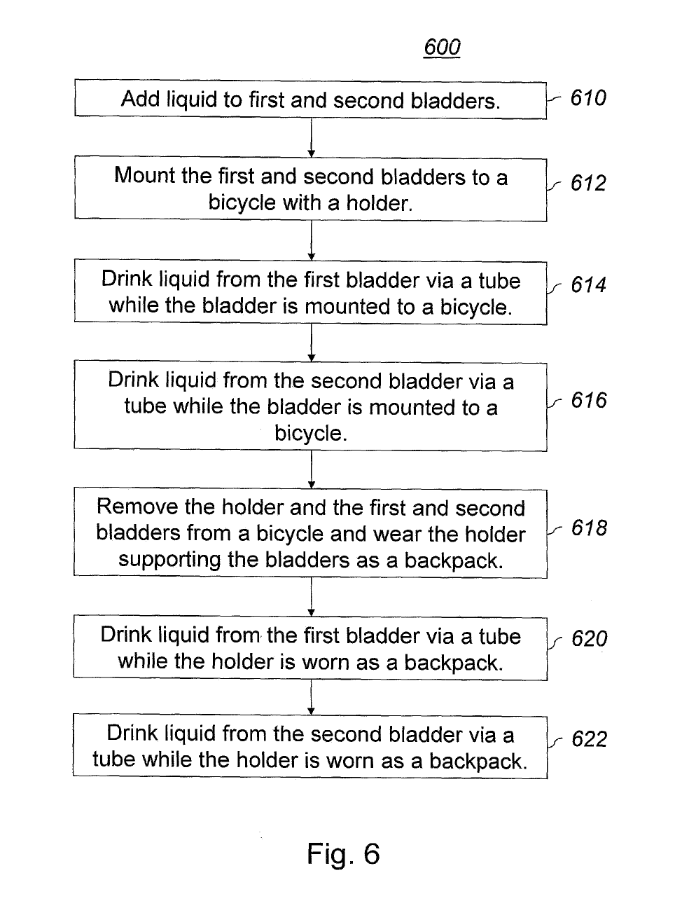

Another illustrative embodiment provides a method 600 of drinking liquid from to first and second bladders, as illustrated in FIG. 6. Although method 600 may be performed with various hydration systems, method 600 will be explained with respect to system 10 depicted in FIGS. 1A-1D solely for illustrative purposes. Liquid is added to first bladder 20 and second bladder 30 in a step 610. First bladder 20 and second bladder 30 are mounted to a bicycle 90 with a holder 50 in a step 612. In a step 614, liquid is drunk from first bladder 20 via a tube 22 while bladder 20 is mounted to a bicycle 90. Liquid is drunk from a second bladder 30 via a tube 32 while bladder 30 is mounted to a bicycle 90 in a step 616. In a step 618, holder 50, first bladder 20 and second bladder 30 are removed from a bicycle 90, and holder 50 is worn as a backpack that supports first bladder 20 and second bladder 30. Liquid is drunk from first bladder 20 via a tube while holder 50 is worn as a backpack in a step 620. Liquid is drunk from the second bladder 30 via a tube while holder 50 is worn as a backpack in a step 622. In some embodiments, mounting first bladder 20 and second bladder 30 to a bicycle 90 with holder 50 may include placing holder over a top bar 92 of bicycle 90, such that first bladder 20 hangs from one side of a top bar 92 of a bicycle and second bladder 30 hangs from a second side of the top bar, opposite the first side. Method 600 may also include placing first bladder 20 into holder 50 at a first inward-facing side 56 and placing second bladder 30 into holder 50 at second inward-facing side 58.

All features and descriptions of a left portion of a holder may also be applied to a right portion of a holder. Likewise, all features and descriptions of a first outward-facing side may also be applied to a second outward-facing side, and all features and descriptions of a first inward-facing side may also be applied to a second inward-facing side.

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A bicycle-mountable hydration system comprising:
a first bladder and a second bladder, each of the first and second bladders being configured to contain liquid and each having a port; and
a holder comprising:
a left portion configured to receive the first bladder;
a right portion configured to receive the second bladder; and
a middle portion connecting the left portion and the right portion; and
the holder being configured to be supported by a top bar of a bicycle such that a first inward-facing side of the left portion faces a second inward-facing side of the right portion.

2. The system of claim 1, wherein the left portion of the holder is configured to receive the first bladder at the first inward-facing side and the right portion of the holder is configured to receive the second bladder at the second inward-facing side.

3. The system of claim 1, wherein the middle portion is configured to hang over the top bar of a bicycle along a substantial length of the top bar and distribute a weight of the holder, the first and second bladders, and the liquid contained in the first and second bladders.

4. The system of claim 1, further comprising:
a first tube connected to at least the port of the first bladder for delivery of a liquid from the first bladder; and
a second tube connected to at least the port of the second bladder for delivery of a liquid from the second bladder.

5. The system of claim 4, wherein the first tube comprises an outlet configured to deliver liquid to a user's mouth.

6. The system of claim 4, further comprising a third tube connected to the first tube and connected to the second tube, the third tube being configured to deliver liquid from the first tube to a user and to deliver liquid from the second tube to a user.

7. The system of claim 6, wherein the system further comprises a switchable coupler configured to adjust a fluid connection between the first tube and the third tube, and configured to adjust a fluid connection between the second tube and the third tube.

8. The system of claim 1, wherein the first bladder is accessible from a first to outward-facing side of the left portion and the second bladder is accessible from a second outward-facing side of the right portion.

9. The system of claim 1, wherein the system is convertible to a backpack configured to support the holder in contact with a back of a user.

10. The system of claim 1, wherein an inward-facing side of the middle portion comprises a material having sufficient grip to prevent sliding of the holder relative to a top bar of a bicycle.

11. The system of claim 1, wherein the holder comprises a deformable material.

12. The system of claim 1, where in the middle portion has sufficient strength to support at least the weight of the holder, the first bladder full of liquid and the second bladder full of liquid without substantial stretching of the middle portion.

13. A convertible bicycle-mountable personal hydration system comprising:
a first bladder and a second bladder, each of the first bladder and the second bladder being configured to contain liquid and each having a port;
a holder comprising:
a left portion configured to receive the first bladder;
a right portion configured to receive the second bladder; and
a middle portion connecting the left portion and the right portion and configured to support the holder and the first and second bladders from a top bar of a bicycle such that a first inward-facing side of the left portion faces a second inward-facing side of the right portion when the system is mounted on the bicycle; and
a first strap connected with the holder, the first strap and holder being configured to receive a user's arm and support the holder and the bladders such that the holder contacts the user's back.

14. The system of claim 13, further comprising a second strap connected with the holder, the second strap and holder being configured to receive a user's other arm and configured to support the holder and the bladders such that the holder contacts the user's back.

15. The system of claim 13, wherein the first strap and the holder are configured to support the holder and the bladders such that the first inward-facing side of the left portion and the second inward-facing side of the right portion contact the user's back.

16. The system of claim 13, the holder further comprising a first tube guide configured to position a tube extending from the port of the first bladder and/or the port of the second bladder.

17. The system of claim 16, wherein the first tube guide is configured to position the tube to extend toward a front end of a bicycle when the system is mounted on the bicycle.

18. The system of claim 17, further comprising a second tube guide configured to position a tube extending from the port of the first bladder or the port of the second bladder.

19. The system of claim 13, wherein the holder further comprises at least one pocket that is dimensioned to hold a bicycle pump and that is accessible from the first outward-facing side of the left portion of the holder and/or the second outward-facing side of the right portion of the holder.

20. The system of claim 13, wherein the first strap is attached to the first inward-facing side of the right portion of the holder and/or the second inward-facing side of the left portion.

21. The system of claim 13, wherein the holder further comprises:
a down tube attachment element configured to attach the holder to a down tube of a bicycle; and
a seat tube attachment element configured to attach the holder to a seat tube of a bicycle.

22. The system of claim 13, further comprising a waist belt having a first part attached to the left portion of the holder and a second part attached to the right portion of the holder.

23. A method of drinking liquid from first and second bladders comprising:
adding liquid to first and second bladders;
mounting the first and second bladders to a bicycle with a holder;
drinking liquid from the first bladder via a tube while the bladders are mounted to the bicycle;
drinking liquid from the second bladder via a tube while the bladders are mounted to the bicycle;
removing the holder and the first and second bladders from the bicycle and wearing the holder as a backpack;
drinking liquid from the first bladder via a tube while the holder is worn as a backpack; and
drinking liquid from the second bladder via a tube while the while the holder is worn as a backpack.

24. A method as in claim 23, wherein mounting the first and second bladders to a bicycle with a holder comprises placing the holder over a top bar of the bicycle such that the first bladder hangs from one side of the top bar and the second bladder hangs from a second side of the top bar, opposite the first side.

25. A method as in claim 23, further comprising placing the first bladder into a left portion of the holder and placing the second bladder into a right portion of the holder.

26. A method as in claim 25, wherein the first bladder is placed into a first inward-facing side of the left portion of the holder and the second bladder is placed into a to second inward-facing side of the right portion of the holder.
